(19) United States
(12) Patent Application Publication
(10) Pub. No.: US 2026/0144613 A1
(43) Pub. Date: May 28, 2026

(54) METHOD FOR DETECTING MORPHOLOGICAL DIFFERENCE BETWEEN THREE-DIMENSIONAL DIGITAL MODELS OF TOOTH

(71) Applicant: SHANGHAI EA MEDICAL INSTRUMENTS COMPANY LIMITED, Shanghai (CN)

(72) Inventors: Mingzheng WANG, Shanghai (CN); Yang FENG, Shanghai (CN)

(21) Appl. No.: 19/123,306

(22) PCT Filed: Oct. 26, 2023
(86) PCT No.: PCT/CN2023/126938

§ 371 Date: Apr. 22, 2025

(30) Foreign Application Priority Data
Oct. 26, 2022 (CN) 202211322327.1

(51) Int. Cl. A61C 7/00; G06F 30/20

(52) U.S. Cl. CPC A61C 7/002; G06F 30/20; A61C 2007/004

(57) ABSTRACT

A computer-implemented method for detecting a morphological difference between three-dimensional digital models of a tooth includes: obtaining first and second three-dimensional digital models which are two three-dimensional digital models representing a same tooth; performing alignment between the first and second three-dimensional digital models; based on the first and second three-dimensional digital models after the alignment, determining vertices of the first three-dimensional digital model and corresponding points of the second three-dimensional digital model to constitute a first point pair set comprising multiple first point pairs; dividing the multiple first point pairs into groups based on distances of respective first point pairs; and detecting a morphological difference between the first and second three-dimensional digital models by determining a category of a morphological difference in a region corresponding to each group based on distances of first point pairs in the each group.

### CROSS REFERENCE TO RELATED APPLICATIONS

The present disclosure is a national phase entry under 35 U.S.C. § 371 of International Application No. PCT/CN2023/126938 filed on Oct. 26, 2023, and claims priority of Chinese Patent Application No. 202211322327.1, filed with the China National Intellectual Property Administration (CNIPA) on Oct. 26, 2022, the entire content of which is incorporated herein by reference.

### TECHNICAL FIELD

The present application generally relates to a method for detecting a morphological difference between three-dimensional digital models of a tooth.

### BACKGROUND

With the continuous development of computer science, dental professionals are increasingly relying on computer technology to improve the efficiency of dental treatment.

The three-dimensional digital model of the dentition is one of the most commonly used data in dental treatment. Typically, the three-dimensional digital model of the dentition can be obtained by intraoral scanning, or by scanning a physical model (e.g., a plaster model) or impression of the dentition.

In the process of orthodontic treatment using shell-style orthodontic appliances, scanning is usually performed for multiple times at different time points to obtain three-dimensional digital models of the patient's dentition. The three-dimensional digital models of the patient's dentition are used for analyzing during the actual treatment. Due to factors such as different scanning devices used, the installation and uninstallation of attachments, tooth wear, and changes in the gum line, there may be a morphological difference between the three-dimensional digital models of the same tooth obtained by scanning at different time points.

Currently, the morphological difference between two three-dimensional digital models of the same tooth is detected manually using general three-dimensional digital model processing software. However, this method has problems such as low efficiency, poor consistency, insufficient precision, and easy neglect of a minor morphological difference.

Therefore, it is necessary to provide a new method for detecting the morphological difference between three-dimensional digital models of a tooth.

### SUMMARY

One aspect of the present application provides a computer-implemented method for detecting a morphological difference between three-dimensional digital models of a tooth. The method includes: obtaining first and second three-dimensional digital models which are two three-dimensional digital models representing the same tooth; performing coarse alignment between the first and second three-dimensional digital models based on a local coordinate system of the first and second three-dimensional digital models; performing fine alignment between the first and second three-dimensional digital models after the coarse alignment using an ICP method; based on the first and second three-dimensional digital models after the fine alignment, casting rays along a normal direction from vertices of the first three-dimensional digital model to obtain intersection points of the rays with the second three-dimensional digital model, the intersection points and corresponding vertices constituting a first point pair set including multiple first point pairs; and detecting the morphological difference between the first and second three-dimensional digital models based on distances of the first point pairs in the first point pair set.

In some embodiments, the coarse registration is performed according to an SVD method.

In some embodiments, the coarse alignment is performed by: selecting a plurality of pairs of reference points in the local coordinate system of the first and second three-dimensional digital models, each pair of reference points having same coordinate values, and performing the coarse alignment between the first and second three-dimensional digital models based on the plurality of pairs of reference points.

In some embodiments, weights of second point pairs on which the fine alignment is based are assigned according to at least one of following: (1) weights are assigned according to long axis coordinates of the local coordinate system: a second point pair closer to an incisal edge or occlusal surface of the tooth has a higher weight, and a second point pair closer to a gum line has a lower weight; (2) weights are assigned according to the second point pairs sorted by distance: in each iteration of the ICP method, the second point pairs are sorted from large to small by distance, and a second point pair with a larger distance has a lower weight; or (3) weights are assigned according to a preset distance threshold: in each iteration of the ICP method, based on that a distance of a second point pair exceeds the preset distance threshold, a weight of the second point pair is reduced.

In some embodiments, the computer-implemented method for detecting the morphological difference between three-dimensional digital models of the tooth further includes: calculating a confidence level of the fine alignment based on a proportion of second point pairs that complete the fine alignment.

In some embodiments, the computer-implemented method for detecting the morphological difference between three-dimensional digital models of the tooth further includes: based on the first and second three-dimensional digital models after the coarse alignment, casting rays along the normal direction from vertices of one of the first and second three-dimensional digital models to obtain intersection points of the rays with the other of the first and second three-dimensional digital models. The intersection points and corresponding vertices constitute a second point pair set including multiple second point pairs, which serve as the second point pairs on which the fine alignment is based.

In some embodiments, the computer-implemented method for detecting the morphological difference between three-dimensional digital models of the tooth further includes: comparing a distance of a first point pair in the first point pair set with a preset first distance threshold; and in response to that the distance of the first point pair is greater than the preset first distance threshold, determining a morphological difference exists at the first point pair.

In some embodiments, the computer-implemented method for detecting the morphological difference between three-dimensional digital models of the tooth further includes: grouping intersection points or vertices of first point pairs, a distance of each of which is greater than the preset first distance threshold, in the first point pair set according to connectivity; and determining a category of a morphological difference in a region corresponding to each group based on distances of first point pairs corresponding to the each group and a location of the each group.

In some embodiments, the computer-implemented method for detecting the morphological difference between three-dimensional digital models of the tooth further includes: calculating a representative distance for the each group based on the distances of the first point pairs corresponding to the each group; comparing the representative distance for the each group with a preset second distance threshold; in response to that the representative distance for the each group is less than the preset second distance threshold, determining the morphological difference in the region corresponding to the each group is a morphological difference caused by tooth wear; in response to that the representative distance for the each group is greater than the preset second distance threshold and the each group is located at an edge of the tooth, determining the morphological difference in the region corresponding to the each group is a morphological difference caused by changes in a gum line; in response to that the representative distance for the each group is greater than the preset second distance threshold and the each group is located inside the tooth, determining the morphological difference in the region corresponding to the each group is a morphological difference caused by an attachment. The preset second distance threshold is greater than the preset first distance threshold.

In some embodiments, the preset second distance threshold is determined based on a maximum value of the morphological difference caused by tooth wear.

In some embodiments, the computer-implemented method for detecting the morphological difference between three-dimensional digital models of the tooth further includes: displaying a category and degree of the morphological difference on a display device in a graphical form.

In some embodiments, based on that a ray casted along the normal direction from a vertex of the first three-dimensional digital model has no intersection point with the second three-dimensional digital model, it is determined that the morphological difference caused by changes in the gum line exists at the vertex of the first three-dimensional digital model.

In some embodiments, the preset first distance threshold is determined based on a scanning accuracy for the first or second three-dimensional digital model.

### BRIEF DESCRIPTION OF DRAWINGS

The above and other features of the present application will be further described below in conjunction with the accompanying drawings and detailed description thereof. It should be understood that these drawings only illustrate several exemplary embodiments according to the present application and therefore should not be considered to limit the scope of protection of the present application. Unless otherwise indicated, the drawings are not necessarily to scale and similar reference numbers represent similar components.

FIG. 1 is a schematic flow chart of a computer-implemented method for detecting a morphological difference between three-dimensional digital models of a tooth according to an embodiment of the present application.

FIG. 2 shows a result of detecting a morphological difference between three-dimensional digital models of a tooth in an example displayed on an interface of a computer program for performing the detecting of the morphological difference between three-dimensional digital models of the tooth according to an embodiment of the present application.

FIG. 3 schematically shows a local coordinate system set for a three-dimensional digital model of a tooth.

FIG. 4 shows examples of determining point pairs on which the fine alignment is based.

FIG. 5 shows examples of determining point pairs on which the morphological difference detection is based.

### DETAILED DESCRIPTION

The following detailed description makes reference to the accompanying drawings, which form a part of the specification. The exemplary embodiments mentioned in the specification and drawings are for illustrative purposes only and are not intended to limit the scope of protection of the present application. In light of this application, those skilled in the art will appreciate that many other embodiments may be adopted and that various changes may be made to the described embodiments without departing from the spirit and scope of protection of this application. It should be understood that the various aspects of the present application described and illustrated herein may be arranged, replaced, combined, separated and designed in many different configurations, all of which are within the scope of protection of the present application.

One aspect of the present application provides a computer-implemented method for detecting a morphological difference between three-dimensional digital models of a tooth.

Another aspect of the present application provides a computer system for detecting a morphological difference between three-dimensional digital models of a tooth, which includes a storage device and a processor. The storage device stores a computer program for detecting the morphological difference between three-dimensional digital models of the tooth. When the computer program is executed by the processor, the method for detecting the morphological difference between three-dimensional digital models of the tooth is performed.

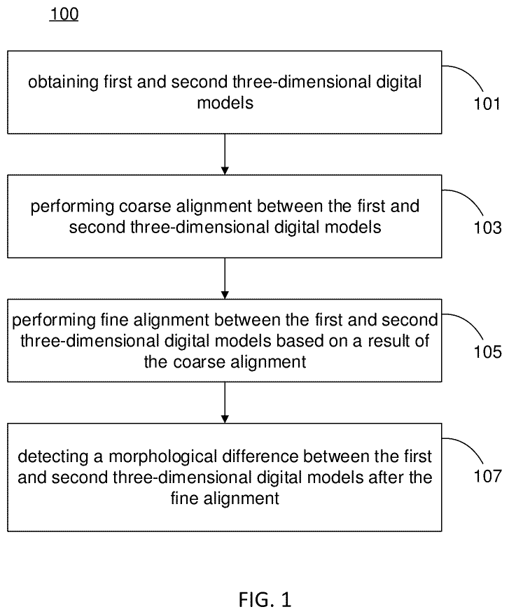

Please refer to FIG. 1, which is a schematic flowchart of a computer-implemented method 100 for detecting a morphological difference between three-dimensional digital models of a tooth according to an embodiment of the present application.

In 101, first and second three-dimensional digital models are obtained.

The first and second three-dimensional digital models are three-dimensional digital models of the same tooth obtained by scanning at different time points.

As is known to those skilled in the art, orthodontic treatment for a dentition (maxillary or mandibular dentition) using shell-style orthodontic appliances usually requires dozens of successive shell-style orthodontic appliances. Each shell-style orthodontic appliance corresponds to a treatment step and is used to reposition the dentition from the tooth arrangement achieved in the previous treatment step to the target tooth arrangement in the current treatment step.

Typically, a shell-style orthodontic appliance is manufactured based on a three-dimensional digital model of the dentition. For example, before orthodontic treatment, a three-dimensional digital model of the patient's dentition is obtained by scanning and then segmented so that each tooth and gum is independent of each other. Then, based on the segmented three-dimensional digital model of the dentition, three-dimensional digital models of the dentition for manufacturing a series of shell-style orthodontic appliances for successive treatment steps are generated. These three-dimensional digital models of the dentition are hereinafter referred to as target three-dimensional digital models of the dentition.

During orthodontic treatment, it is sometimes necessary to obtain a three-dimensional digital model of the patient's dentition by rescanning, and compare the obtained three-dimensional digital model of the patient's dentition with a corresponding target three-dimensional digital model of the dentition. Due to factors such as the installation and uninstallation of attachments, tooth wear, and changes in the gum line, there may be morphological difference(s) between the three-dimensional digital model of a tooth of the dentition obtained by rescanning and the corresponding target three-dimensional digital model of the same tooth of the dentition. This is an application scenario of the method for detecting the morphological difference between three-dimensional digital models of the tooth of the present application.

In light of the present application, it can be understood that the method for detecting the morphological difference between three-dimensional digital models of the tooth of the present application is not limited to the above application scenario and can be used to detect morphological difference(s) between any two three-dimensional digital models of the same tooth.

In 103, the first and second three-dimensional digital models are coarsely aligned.

A three-dimensional digital model of the entire dentition (maxillary or mandibular dentition) is generally obtained by scanning. In an embodiment, teeth in the three-dimensional digital model of the dentition are numbered in a predetermined manner. Teeth in two three-dimensional digital models of the same dentition can be paired based on tooth numbers, to ensure that the two three-dimensional digital models used as morphological comparison objects are three-dimensional digital models of the same tooth.

As known to those skilled in the art, in processing the three-dimensional digital model of the dentition, in order to facilitate calculation, in addition to the world coordinate system, a local coordinate system is usually set for the three-dimensional digital model of each tooth. For example, referring to FIG. 3, the origin O of the local coordinate system is located at the center of the tooth 11. The three axes (X, Y, Z) of the local coordinate system correspond to a long axis of the tooth 11, a mesiodistal direction of the tooth 11, and a labiolingual direction of the tooth 11.

The local coordinate system can be set with extremely high accuracy and consistency using current technologies (e.g., local coordinate system setting methods based on deep learning). Therefore, in an embodiment, two three-dimensional digital models of the same tooth may be coarsely aligned based on the local coordinate system.

In an embodiment, for the first and second three-dimensional digital models, at least three points on the three axes (X, Y, Z) of the local coordinate system of the first and second three-dimensional digital models may be selected as reference points. The two three-dimensional digital models of the tooth may be coarsely aligned based on these reference points. For example, four points (0, 0, 0), (1, 0, 0), (0, 1, 0), and (0, 0, 1) may be used as reference points. It can be understood that the selection of reference points is not limited to this example, as long as they are not on the same straight line. For example, as shown in FIG. 3, reference points A, B, and C are three selected reference points.

In some cases, there may be differences between the first and second three-dimensional digital models. For example, tooth wear, installation/uninstallation of attachments, or changes in the gum line (for example, which may be caused by the growth of erupted teeth, vertical movement or tilt of teeth, etc.) may cause differences between the three-dimensional digital models of the same tooth scanned at different time points.

If there are significant differences between two three-dimensional digital models of the same tooth, for example, three-dimensional digital models obtained by scanning at different time points during the tooth eruption process may have significant morphological differences, coarse alignment between the two three-dimensional digital models of the same tooth based on the local coordinate system may not work well. In such cases, feature points can be used as reference points for alignment, such as buccal cusp points, facial axis (FA) points, and proximal contact points. At present, there are many methods for identifying feature points on a three-dimensional digital model of teeth, for example, a feature point identification method based on deep learning. The identification of feature points will not be described in detail here.

In an embodiment, measurements can be made on two three-dimensional digital models of the same tooth, for example, measuring the mesiodistal width and crown height of the tooth. By comparing difference of the measurement results with a preset threshold, it can be determined whether there is a significant difference between the two three-dimensional digital models of the same tooth. If there is a significant difference, the feature points are used as reference points for coarse alignment. Otherwise, for convenience, coarse alignment can be performed based on the local coordinate system.

In an embodiment, the first and second three-dimensional digital models may be coarsely aligned based on the reference points using a Singular Value Decomposition (SVD) method.

In 105, based on the coarse alignment result, the first and second three-dimensional digital models are finely aligned.

After the coarse alignment, the first and second three-dimensional digital models are roughly aligned. On this basis, the teeth in pairs can be finely aligned.

In an embodiment, an iterative closest point algorithm (hereinafter referred to as ICP algorithm) may be used to finely align two three-dimensional digital models of the same tooth.

In an embodiment, the first and second three-dimensional digital models may be finely aligned based on a point-to-surface approach.

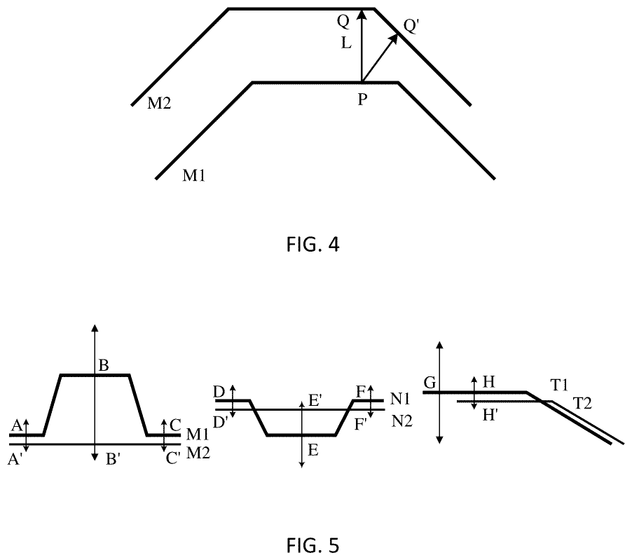

In an embodiment, point pairs for the fine alignment may be determined according to the following method. Some vertices sampled or all vertices selected from the first three-dimensional digital model are taken as a first point set for the fine alignment. For each point in the first point set, a ray is cast from the point along the normal direction. An intersection point of the ray with the second three-dimensional digital model (i.e., the intersection point of the ray with a surface of the second three-dimensional digital model) is obtained. The starting point of the ray and the intersection point are taken as a point pair. For example, referring to FIG. 4, for the point P selected on the first three-dimensional digital model M1, a ray L is cast from the point P along the normal direction. An intersection point Q of the ray L with the second three-dimensional digital model M2 is obtained. {P, Q} is a point pair.

Since the relative positional relationship between the first and second three-dimensional digital models is unknown, the intersection point of a unidirectional ray with the second three-dimensional digital model may not necessarily be a valid intersection point. Therefore, rays can be cast from a vertex on the first three-dimensional digital model along the normal direction in two opposite directions, or a straight line along the normal direction can be drawn passing through the vertex on the first three-dimensional digital model. In this way, two intersection points with the second three-dimensional digital model may be obtained, and the closer intersection point is selected.

In addition, the second three-dimensional digital model may lack a portion which is in the first three-dimensional digital model. Therefore, a threshold can be set. If the distance between a vertex and each corresponding intersection point is greater than the threshold, it is considered that the rays from the vertex along the normal direction have no valid intersection point with the second three-dimensional digital model.

In another embodiment, the first and second three-dimensional digital models may be finely aligned based on a point-to-point approach.

In an embodiment, point pairs for the fine alignment may be determined according to the following method. Some vertices sampled or all vertices selected from the first three-dimensional digital model are taken as a first point set for the fine alignment. For each point in the first point set, a vertex on the second three-dimensional digital model closest to the point is found, and the two vertices are taken as a point pair. For example, referring to FIG. 4, for the point P selected on the first three-dimensional digital model M1, a vertex Q′ on the second three-dimensional digital model M2 closest to the point P is found. {P, Q′} is a point pair.

In an embodiment, a first distance threshold may be set. During the iteration process, if the distance of a point pair is less than the first distance threshold, the point pair is considered to have completed the alignment. In an embodiment, the first distance threshold may be determined according to the accuracy (e.g., 0.1 mm or 0.2 mm) of a scanning device that generates the first and/or second three-dimensional digital models. For example, if the accuracy of the scanning device used is 0.1 mm, then the first distance threshold may be set to 0.08 mm, or 0.1 mm, or 0.12 mm, etc. It is understandable that the first distance threshold is not required to be equal to the scanning accuracy. Based on specific circumstances and requirements, a value within a certain range above and below the scanning accuracy can be selected as the first distance threshold.

In an embodiment, a proportion threshold may be set. If the proportion of point pairs that have completed the alignment is greater than the proportion threshold, it is considered that the fine alignment of the first and second three-dimensional digital models is completed.

In an embodiment, the following conditions can be set. If any one of these conditions is met, the iteration is stopped: (1) the proportion of point pairs that have completed the alignment is greater than the proportion threshold; (2) the number of iterations exceeds a preset iteration number threshold; and (3) the difference between the pose after this iteration and the pose after the previous iteration is less than a preset pose difference threshold (a comprehensive evaluation based on translation and rotation displacements).

Although the first and second three-dimensional digital models correspond to the same tooth, as mentioned above, due to wear, installation/uninstallation of attachment, and changes in the gum line, the first and second three-dimensional digital models may not completely overlap. Therefore, it is necessary to minimize the influence of these factors as much as possible during the alignment process.

In an embodiment, at least one of the following methods may be used to assign weights to the points on which the fine alignment is based, so as to minimize the influence of the above factors on the fine alignment.
(1) Weights are assigned according to long axis coordinates of the local coordinate system. A point pair closer to an incisal edge or occlusal surface of the tooth has a higher weight, while a point pair closer to a gum line has a lower weight, so as to minimize the interference caused by the change of the gum line.
(2) Weights are assigned according to point pairs sorted by distance. In each iteration, point pairs are sorted from large to small by distance, and a point pair with a larger distance has a lower weight, so as to minimize interference caused by morphological differences.
(3) Weights are assigned according to a distance threshold. The distance threshold can be set in advance. For example, the distance threshold can be set based on the scanning accuracy (the magnitude is consistent with the scanning accuracy, and the specific value can be adjusted according to the actual situation). In each iteration, if the distance of a point pair exceeds the distance threshold, it is considered that the distance of the point pair is caused by morphological differences, and a weight of the point pair is reduced. The weight of the point pair can even be reduced to zero, that is, the point pair does not participate in this iteration.

When the iteration of fine alignment stops, the following results are output.
(1) a rigid transformation (translation and rotation in three-dimensional space) between the first and second models.
(2) a confidence level: the proportion of point pairs that have completed the alignment. The higher the proportion, the higher the confidence level, indicating that the alignment result is more reliable and can be used as a reference for subsequent processing.
(3) an anomalous point: a point pair(s) that has/have not completed the alignment when the iteration stops. For example, the distance(s) of the point pair(s) can be compared with the above-mentioned distance threshold, and the point pair(s) with distance(s) greater than the distance threshold is/are regarded as having the morphological difference(s) between the first and second models.

In 107, morphological difference(s) between the first and second three-dimensional digital models after the fine alignment is/are detected.

In an embodiment, a set of point pairs on which morphological difference detection is based may be selected from the first and second three-dimensional digital models after alignment.

In an embodiment, some vertices sampled or all vertices selected from the first three-dimensional digital model are taken as a third point set. For each point in the third point set, a ray is cast from the point along the normal direction. An intersection point of the ray with the second three-dimensional digital model (i.e., the intersection point of the ray with a surface of the second three-dimensional digital model) is obtained. The starting point of the ray and the intersection point are taken as a point pair for obtaining a fourth point pair set. The point pairs obtained above constitute the point pair set on which the morphological difference detection is based. For example, referring to FIG. 5, a morphological difference between three-dimensional digital models M1 and M2 of a tooth is to be detected. Three vertices A, B, and C sampled from the first three-dimensional digital model M1 are taken as a third point set {A, B, C}. For each point in the third point set {A, B, C}, a ray is cast from the point along the normal direction to obtain intersection points A′, B′, and C′ of the ray with the second three-dimensional digital model M2. The point pair set {(A, A′), (B, B′), (C, C′)} on which the morphological difference between three-dimensional digital models M1 and M2 of the tooth is based is obtained. Referring to FIG. 5, a morphological difference between three-dimensional digital models N1 and N2 of a tooth is to be detected. Three vertices D, E, and F sampled from the first three-dimensional digital model N1 are taken as a third point set {D, E, F}. For each point in the third point set {D, E, F}, a ray is cast from the point along the normal direction to obtain intersection points D′, E′, and F′ of the ray with the second three-dimensional digital model N2. The point pair set {(D, D′), (E, E′), (F, F′)} on which the morphological difference between three-dimensional digital models N1 and N2 of the tooth is based is obtained. Referring to FIG. 5, a morphological difference between three-dimensional digital models T1 and T2 of a tooth is to be detected. Two vertices G and H sampled from the first three-dimensional digital model T1 are taken as a third point set {G, H}. For each point in the third point set {G, H}, a ray is cast from the point along the normal direction to obtain intersection points H′ of the ray with the second three-dimensional digital model T2. The point pair set {(H, H′)} on which the morphological difference between three-dimensional digital models T1 and T2 of the tooth is based is obtained. A ray from the point G does not have an intersection point with the second three-dimensional digital model T2. In FIG. 5, two rays in two opposite directions are casted along the normal direction. However, the present application does not limit to this. In some embodiments, only one unidirectional ray may be casted along the normal direction. In some other embodiments, a straight line may be drawn along the normal direction passing through the vertex on the first three-dimensional digital model.

In some cases, some rays along the normal direction have no intersection point with the second three-dimensional digital model. In such cases, it is considered that there is a boundary morphology change at the starting points of the rays along the normal direction. The boundary morphology change is caused by changes in the gum line. For example, referring to FIG. 5, a ray from the point G does not have an intersection point with the second three-dimensional digital model T2, thus it is determined that a morphological difference caused by changes in the gum line exists at the point G.

In some cases, the rays along the normal direction from the first three-dimensional digital model cannot completely cover the second three-dimensional digital model, and the rays along the normal direction from the second three-dimensional digital model cannot completely cover the first three-dimensional digital model. In a morphological difference detection, one of the two three-dimensional digital models is used as a reference model (i.e., the model where the intersection points are located) to detect which regions of the other model have morphological differences. Thus morphological differences between the two models may not be fully reflected through a unidirectional detection. In this case, to detect all the differences between the two models, a bidirectional detection can be performed, and then results of the two detections are merged to obtain the final detection result.

In an embodiment, it can be determined based on the distance between each point pair whether there is a morphological difference between the first and second three-dimensional digital models at the point pair, and if there is a morphological difference, which category of morphological difference the morphological difference belongs to. If a distance of a point pair is less than a first distance threshold, it represents that the first and second three-dimensional digital models are highly overlapped at the point pair. If a distance of a point pair is greater than a first distance threshold and less than a second distance threshold, it represents that a certain difference between the first and second three-dimensional digital models exists at the point pair. If a distance of a point pair is greater than a second distance threshold, it represents that a significant difference between the first and second three-dimensional digital models exists at the point pair. Referring to FIG. 5, the distance of each of point pairs AA′ and CC′ is less than the first distance threshold, it represents that the first and second three-dimensional digital models M1, M2 are highly overlapped at the point pairs AA′ and CC′. The distance of point pair BB′ is greater than the second distance threshold, it represents that a significant difference between the first and second three-dimensional digital models M1, M2 exists at the point pair BB′. The distance of each of point pairs DD′ and FF′ is less than the first distance threshold, it represents that the first and second three-dimensional digital models N1, N2 are highly overlapped at the point pairs DD′ and FF′. The distance of point pair EE′ is greater than the first distance threshold and less than the second distance threshold, it represents that a certain difference between the first and second three-dimensional digital models N1, N2 exists at the point pair EE′. The distance of point pair HH′ is less than the first distance threshold, it represents that the first and second three-dimensional digital models T1, T2 are highly overlapped at the point pairs HH′.

In an embodiment, first and second distance thresholds may be set. The category of the morphological difference may be determined based on a comparison of the distance between a point pair with each of the first and second distance thresholds, and the location of the point pair on the tooth. The category of the morphological difference includes a morphological difference caused by tooth wear, a morphological difference caused by changes in a gum line, and a morphological difference caused by an attachment. Referring to FIG. 5, the point pair BB′ is located inside the tooth, and the distance of the point pair BB′ is greater than the second distance threshold, it is determined that the morphological difference at the point pair BB′ is a morphological difference caused by an attachment. The point pair EE′ is located in the tooth, and the distance of the point pair EE′ is greater than the first distance threshold and less than the second distance threshold, it is determined that the morphological difference at the point pair EE′ is a morphological difference caused by tooth wear.

In an embodiment, the first distance threshold may be set based on scanning accuracy. For example, if the scanning accuracy is 0.1 mm, the first distance threshold may be set to 0.1 mm accordingly. It can be understood that the first distance threshold is not required to be equal to the scanning accuracy, and it can also be slightly smaller or larger than the scanning accuracy. If the distance between a point pair (i.e., the distance of a point pair) is less than the first distance threshold, it is considered that there is no morphological change at the point pair. Otherwise, it is considered that there is a morphological change at the point pair.

In an embodiment, the second distance threshold may be set based on an upper limit of the morphological change (usually wear) of the tooth. For example, if it is considered that the morphological change (for example, the morphological change caused by wear) of the tooth within a certain period of time does not exceed 0.5 mm, the second distance threshold can be set to 0.5 mm accordingly.

In an embodiment, point pairs, a distance of each of which is greater than the first distance threshold, can be grouped according to connectivity. For a group of point pairs, the category of the morphological change in the region corresponding to the group of point pairs can be determined according to the location of the group of point pairs on the three-dimensional digital model of the tooth and the distances of the point pairs (for example, the average of the distances of the point pairs, or the average of distances of point pairs selected from the group of point pairs according to a predetermined ratio with larger distances, or the maximum distance among the distances of the point pairs, etc.).

For example, when the maximum distance among the distances of the point pairs is greater than the first distance threshold and less than the second distance threshold, it is considered that there are morphological changes of the teeth in the region corresponding to the group of point pairs on the first and second three-dimensional digital models. When the maximum distance among the distances of the point pairs is greater than the second distance threshold, and the group of point pairs is located inside the three-dimensional model, it is considered that the morphological difference between the first and second three-dimensional digital models in the region corresponding to the group of point pairs is caused by the attachment. When the maximum distance among the distances of the point pairs is greater than the second distance threshold, and at least one point pair in the group of point pairs is located at the edge of the three-dimensional model, it is considered that the morphological difference between the first and second three-dimensional digital models in the region corresponding to the group of point pairs is caused by changes in the gum line. In an embodiment, when a point pair is located close enough to a boundary, for example, a second-layer or third-layer edge within the boundary, the point pair is also considered to be located at the edge. Further, the region corresponding to the group of point pairs including this point pair is considered to be located at the edge.

In an embodiment, when detecting morphological changes, one of the first and second three-dimensional digital models can be used as a reference model. Based on the distances and connectivity of the point pairs, a region with morphological changes is delineated on the other three-dimensional digital model, and the morphological changes are classified into categories. In an embodiment, when detecting morphological differences, rays may be casted from vertices on the other three-dimensional digital model to obtain intersection points with the reference model. Morphological differences may be detected based on the starting points of the rays and intersection points.

In an embodiment, the regions where the morphological differences between the three-dimensional digital model of a tooth and the reference model exist can be displayed on a computer screen in a graphical form. For example, different colors can be used to distinguish the categories of morphological differences, and the depth of the color can be used to indicate the magnitude of the morphological differences.

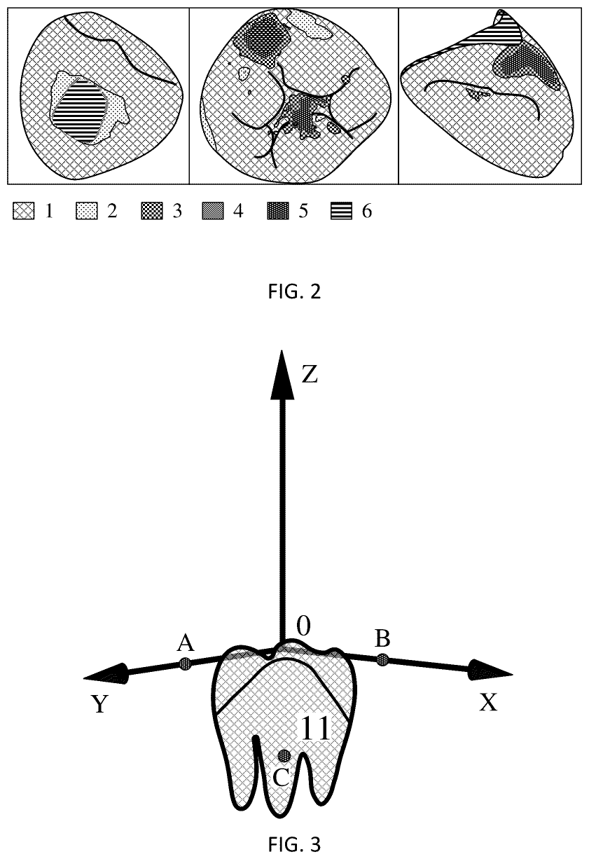

Please refer to FIG. 2, which shows a result of detecting a morphological difference between three-dimensional digital models of a tooth in an example displayed on an interface of a computer program for performing the detecting of the morphological difference between three-dimensional digital models of the tooth according to an embodiment of the present application. In FIG. 2, different categories and degrees of morphological changes are shown by different colors and different color depths. In FIG. 2, different colors (color depths) are denoted by different reference numbers. The three-dimensional digital models are highly overlapped at reference number 1. A certain difference between the three-dimensional digital models exists at reference numbers 2-5. From reference number 2 to reference number 5, the degree of the difference increases. A significant difference between the three-dimensional digital models exists at reference number 6. For example, in the middle tooth of FIG. 2, morphological differences caused by tooth wear exist at reference numbers 3 and 5 on the occlusal surface of the tooth. In the left tooth of FIG. 2, reference number 6 is located inside the tooth and thus represents an attachment. In the right tooth of FIG. 2, reference number 6 is located at an edge of the tooth, and the three-dimensional digital models may not have corresponding part at reference number 6, thus the morphological difference caused by changes in the gum line exists at reference number 6.

Although various aspects and embodiments of the present application are disclosed herein, other aspects and embodiments of the present application will be apparent to those skilled in the art in light of this application. The various aspects and embodiments disclosed herein are for purposes of illustration only and not limitation. The scope and essence of the present application are determined only by the appended claims.

Likewise, the various figures may illustrate exemplary architectures or other configurations of the disclosed methods and systems, which facilitate understanding of features and functionality that may be included in the disclosed methods and systems. What is claimed is not limited to the exemplary architectures or configurations shown, and the desired features may be implemented with a variety of alternative architectures and configurations. In addition, with respect to flow charts, functional descriptions, and method claims, the order of the blocks presented herein should not limit various embodiments to being implemented in the same order to perform the described functionality unless the context clearly dictates otherwise.

Unless expressly stated otherwise, terms and phrases used herein, and variations thereof, should be construed as open ended as opposed to limiting. In some embodiments, the appearance of expansive words and phrases such as “one or more,” “at least,” “but not limited to,” or other similar terms should not be understood as intending or requiring a narrowing in examples where such expansive words may not be present.

1. A computer-implemented method for detecting a morphological difference between three-dimensional digital models of a tooth, comprising:
obtaining first and second three-dimensional digital models which are two three-dimensional digital models representing a same tooth;
performing alignment between the first and second three-dimensional digital models;
based on the first and second three-dimensional digital models after the alignment, determining vertices of the first three-dimensional digital model and corresponding points of the second three-dimensional digital model to constitute a first point pair set comprising multiple first point pairs;
dividing the multiple first point pairs into groups based on distances of respective first point pairs; and
detecting a morphological difference between the first and second three-dimensional digital models by determining a category of a morphological difference in a region corresponding to each group based on distances of first point pairs in the each group; wherein the category comprises at least one of: a morphological difference caused by tooth wear, a morphological difference caused by changes in a gum line, or a morphological difference caused by an attachment.

2-6. (canceled)

7. The computer-implemented method for detecting the morphological difference between three-dimensional digital models of the tooth according to claim 1, further comprising:
comparing a distance of a first point pair in the first point pair set with a preset first distance threshold; and
in response to that the distance of the first point pair is greater than the preset first distance threshold, determining a morphological difference exists at the first point pair.

8. The computer-implemented method for detecting the morphological difference between three-dimensional digital models of the tooth according to claim 7, further comprising:
grouping points or vertices of first point pairs, a distance of each of which is greater than the preset first distance threshold, in the first point pair set according to connectivity; and
determining the category of the morphological difference in the region corresponding to the each group based on distances of first point pairs in the each group and a location of the each group.

9. The computer-implemented method for detecting the morphological difference between three-dimensional digital models of the tooth according to claim 8, further comprising:
calculating a representative distance for the each group based on the distances of the first point pairs in the each group;
determining the category of the morphological difference in the region corresponding to the each group by comparing the representative distance for the each group with a preset second distance threshold;
wherein the determining the category comprises at least one of:
in response to that the representative distance for the each group is less than the preset second distance threshold, determining the morphological difference in the region corresponding to the each group is the morphological difference caused by tooth wear;
in response to that the representative distance for the each group is greater than the preset second distance threshold and the each group is located at an edge of the tooth, determining the morphological difference in the region corresponding to the each group is the morphological difference caused by changes in the gum line; or
in response to that the representative distance for the each group is greater than the preset second distance threshold and the each group is located inside the tooth, determining the morphological difference in the region corresponding to the each group is the morphological difference caused by the attachment;
wherein the preset second distance threshold is greater than the preset first distance threshold.

10. The computer-implemented method for detecting the morphological difference between three-dimensional digital models of the tooth according to claim 9, wherein the preset second distance threshold is determined based on a maximum value of the morphological difference caused by tooth wear.

11. The computer-implemented method for detecting the morphological difference between three-dimensional digital models of the tooth according to claim 1, further comprising:
displaying a category and degree of the morphological difference on a display device in a graphical form.

12. The computer-implemented method for detecting the morphological difference between three-dimensional digital models of the tooth according to claim 1, further comprising:
based on that rays casted along a normal direction from a vertex of the first three-dimensional digital model have no intersection point with the second three-dimensional digital model, determining the morphological difference caused by changes in the gum line exists at the vertex of the first three-dimensional digital model.

13. The computer-implemented method for detecting the morphological difference between three-dimensional digital models of the tooth according to claim 7, wherein the preset first distance threshold is determined based on a scanning accuracy for the first or second three-dimensional digital model.

14. The computer-implemented method for detecting the attachment position deviation according to claim 9, wherein the representative distance is any one of:
an average of the distances of the first point pairs in the each group;
an average of distances of first point pairs selected from the each group in an descending order of the distances of the first point pairs in the each group according to a predetermined ratio; or
a maximum distance among the distances of the first point pairs in the each group.

15. The computer-implemented method for detecting the attachment position deviation according to claim 1, wherein:
one ray is cast along a normal direction from one vertex of the first three-dimensional digital model to obtain one intersection point of the one ray with the second three-dimensional digital model;
wherein the one intersection point and the vertex serve as one first point pair in the first point pair set.

16. The computer-implemented method for detecting the attachment position deviation according to claim 1, wherein:
two rays in two opposite directions are cast along a normal direction from one vertex of the first three-dimensional digital model to obtain two intersection points of the two rays with the second three-dimensional digital model; or
a straight line is drawn along the normal direction passing through one vertex of the first three-dimensional digital models to obtain two intersection points of the straight line with the second three-dimensional digital model;
wherein one of the two intersection points closer to the vertex than the other of the two intersection points and the vertex serve as one first point pair in the first point pair set.

17. The computer-implemented method for detecting the attachment position deviation according to claim 1, wherein:
sampling multiple vertices from the first three-dimensional digital model; and
obtaining, for each vertex of the multiple vertices, a vertex on the second three-dimensional digital model closest to the each vertex;
wherein the each vertex and the vertex obtained server as one first point pair in the first point pair set.

18. The computer-implemented method for detecting the attachment position deviation according to claim 1, wherein the performing alignment between the first and second three-dimensional digital models comprises:
performing coarse alignment between the first and second three-dimensional digital models based on a local coordinate system of the first and second three-dimensional digital models; and
performing fine alignment between the first and second three-dimensional digital models after the coarse alignment using an iterative closest point (ICP) method.

19. The computer-implemented method for detecting the morphological difference between three-dimensional digital models of the tooth according to claim 18, wherein the coarse alignment is performed according to a singular value decomposition (SVD) method.

20. The computer-implemented method for detecting the morphological difference between three-dimensional digital models of the tooth according to claim 18, wherein the coarse alignment is performed by:
selecting a plurality of pairs of reference points in the local coordinate system of the first and second three-dimensional digital models, each pair of reference points having same coordinate values, and
performing the coarse alignment between the first and second three-dimensional digital models based on the plurality of pairs of reference points.

21. The computer-implemented method for detecting the morphological difference between three-dimensional digital models of the tooth according to claim 18, wherein weights of second point pairs on which the fine alignment is based are assigned according to at least one of following:
weights are assigned according to long axis coordinates of the local coordinate system: a second point pair closer to an incisal edge or occlusal surface of the tooth has a higher weight, and a second point pair closer to a gum line has a lower weight;
weights are assigned according to the second point pairs sorted by distance: in each iteration of the ICP method, the second point pairs are sorted from large to small by distance, and a second point pair with a larger distance has a lower weight; or
weights are assigned according to a preset distance threshold: in each iteration of the ICP method, based on that a distance of a second point pair exceeds the preset distance threshold, a weight of the second point pair is reduced.

22. The computer-implemented method for detecting the morphological difference between three-dimensional digital models of the tooth according to claim 18, further comprising:
calculating a confidence level of the fine alignment based on a proportion of second point pairs that complete the fine alignment.

23. The computer-implemented method for detecting the morphological difference between three-dimensional digital models of the tooth according to claim 18, further comprising:
based on the first and second three-dimensional digital models after the coarse alignment, casting rays along the normal direction from vertices of one of the first and second three-dimensional digital models to obtain intersection points of the rays with the other of the first and second three-dimensional digital models;
wherein the intersection points and corresponding vertices constitute a second point pair set comprising multiple second point pairs, which serve as the second point pairs on which the fine alignment is based.

24. The computer-implemented method for detecting the attachment position deviation according to claim 20, wherein at least three pairs of reference points are selected from three axes of the local coordinate system, and coordinate values of the reference points are not on a same axe.

25. The computer-implemented method for detecting the attachment position deviation according to claim 20, wherein the reference points are feature points comprising at least one or a combination of:
buccal cusp points;
facial axis (FA) points; or
proximal contact points.
